(19) United States
(12) Patent Application Publication
(10) Pub. No.: US 2011/0244166 A1
(43) Pub. Date: Oct. 6, 2011

(54) INDUSTRIAL PRODUCT STRUCTURE COMBINED WITH ORGANIC MATERIAL

(76) Inventor: Ching-Tu WANG, Taoyuan County (TW)

(21) Appl. No.: 12/886,967

(22) Filed: Sep. 21, 2010

(30) Foreign Application Priority Data
Apr. 1, 2010 (TW) 099205805

(51) Int. Cl. B32B 9/02; B32B 15/08; B44F 5/00; B44F 9/00

(52) U.S. Cl. 428/67; 428/138; 428/141

(57) ABSTRACT

An industrial product structure combined with organic material is formed in an injection mold which has a mold cavity and at least one injection port to allow an injection material to be injected into the mold cavity. The industrial product formed in the mold includes an organic material layer on the surface, a bottom layer having at least one orifice and an injection material layer located between the organic material layer and bottom layer. The organic material layer and bottom layer are placed in advance in the mold cavity with the orifice of the bottom layer positioned above the injection port of the mold cavity. The injection material is injected through the injection port and orifice to form the injection material layer. The injection material layer has two sides bonded to the organic material layer and bottom layer.

### FIELD OF THE INVENTION

The present invention relates to an industrial product structure combined with organic material and particularly to an industrial product combined with organic material through In-mold decoration (IMD) process.

### BACKGROUND OF THE INVENTION

Industrial products, in addition to providing desirable performance, also must improve appearance, touch feeling and identification of the product through innovative and aesthetic profile design to enhance product orientation and prices on the market. Many conventional industrial products, such as handsets or notebook computers, have plastic casings. Although some of them are coated with paint to provide shades different from plastics, they still have notable plastic touch feeling. After being used for a period of time or subjected to abrasion, the paint on the surface is worn away and the plastic surface is exposed. Hence the plastic casing coated with paint generally does not have attractive appearance and desirable touch feeling.

To improve the surface texture feeling of industrial products, R.O.C. patent No. M321677 entitled “Composite casing structure” discloses a casing consisting of a surface layer and a bottom layer. The surface layer can be formed with patterns through digital or transfer printing. The bottom layer is a metal sheet. A layer of adhesive is provided between the bottom side of the surface layer and the surface of the bottom layer to bond the surface layer and bottom layer together. The surface layer can be a biological material such as cloth, leather, wood skin or the like. The bottom layer (metal sheet) is bonded to the surface layer (cloth, leather, wood skin, etc.) through the adhesive. As such a product is formed by coupling two layers of different materials with varying physical characteristics, when the product is subjected to external factors such as cold, heat or humidity, a slight or deformation could take place. After a period of time, the surface layer and bottom layer could be peeled off and separated. Refer to FIG. 1 for deformation of the biological material. It has a surface layer 91 and a bottom layer 92 interposed and bonded by a layer of adhesive 93. In the event that the surface layer 91 is made of biological material, it is prone to shrink or expand caused by change of cold, heat or humidity. When the surface layer 91 is shrunk, it generates an inward pulling stress while the bottom layer 92 remains intact. If the adhesive 93 cannot withstand the pulling stress for a long duration, the surface layer 91 is separated from the adhesive 93 from the circumferential edges (referring to FIG. 1). Separation speed of the surface layer 91 and bottom layer 92 accelerates, and finally the surface layer 91 could be fully peeled off to expose the unsightly surface of the adhesive 93. Or when the surface layer 91 is expanded, the adhesive 93 cannot withstand the long-term stress and result in a portion of surface of the surface layer 91 peeling off from the adhesive 93 to form bulges or creases. This seriously affects the appearance of product and damages product image and confidence in producers and retailers.

Hence for the industrial products with biological material attached thereon, the biological material must be held securely, and impact caused by thermal expansion, cold shrinkage or humidity alterations should be restrained.

### SUMMARY OF THE INVENTION

In view of the conventional structure with different characteristics on the surface layer and bottom layer that could result in peeling off or forming creases after being subjected to stress for a long period of time and seriously affecting product appearance, it is an object of present invention to provide an industrial product structure formed by injection in a mold with a profile pattern formed at the same time, thereby to reduce the negative impact of stress received by the product.

The present invention provides an industrial product structure combined with organic material. The industrial product is formed in an injection mold which has a mold cavity. The mold also has at least one injection port to allow an injection material to be injected into the mold cavity. The industrial product formed in the mold includes an organic material layer on the surface, a bottom layer having at least one orifice and an injection material layer located between the organic material layer and bottom layer. The organic material layer and bottom layer are disposed in advance in the mold cavity with the orifice of the bottom layer located above the injection port of the mold cavity. The injection material is injected through the injection port and orifice to form the injection material layer. The injection material layer has two sides boned to the organic material layer and bottom layer. The bottom layer can reinforce the physical strength of the organic material layer, and is preferably a metal film to enhance the physical strength.

Compared with the conventional structure, the bottom layer is provided below the organic material layer to enhance the physical strength and restrains warping between the surface layer and bottom layer, thus can avert unsightly appearance caused by warping that might otherwise take place after a long period of time.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional technique.

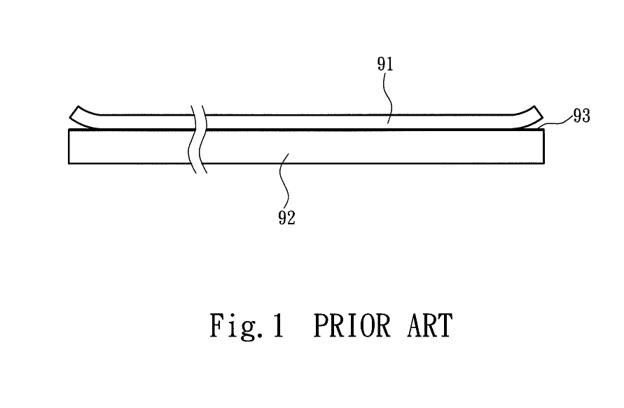

FIG. 2 is a schematic view of the industrial product of the invention during forming.

FIG. 3 is another schematic view of the industrial product of the invention during forming.

FIG. 4 is a schematic view of the industrial product structure.

### DETAILED DESCRIPTION OF THE PREFERRED EMBODIMENT

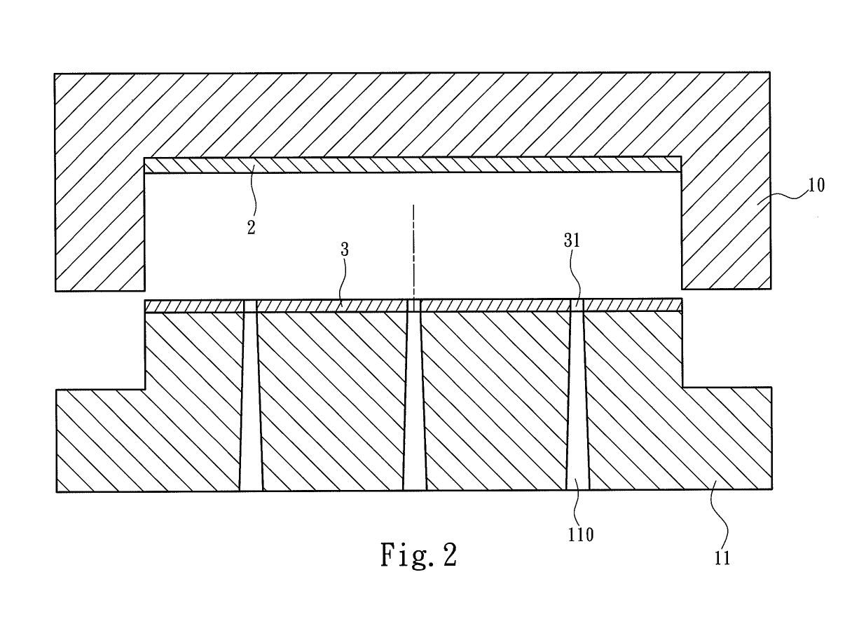

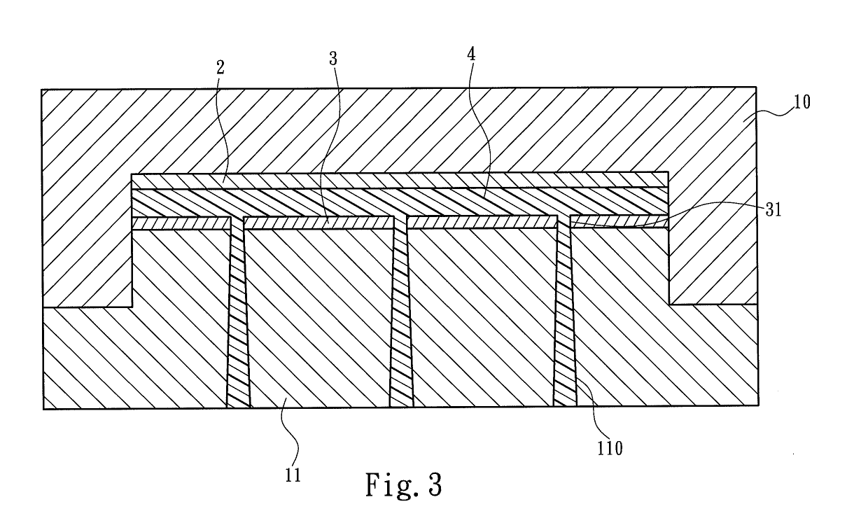

The present invention aims to provide an industrial product structure combined with organic material. Please refer to FIGS. 2 and 3 for the fabrication process of the industrial product prior to forming. The industrial product is formed by injection through an injection mold. The injection mold includes a female mold 10 and a male mold 11 that are coupled together to form a mold cavity. The male mold 11 has at least one injection port 110 to allow an injection material to be injected into the mold cavity. As shown in FIGS. 2 and 3, the male mold 11 may have a plurality of injection ports 110. The injection mold, including the female mold 10 and male mold 11, shown in the drawings is merely an example for illustrative purpose, and is not the limitation of the invention. The invention also includes a bottom layer 3 placed in the mold cavity in advance. The bottom layer 3 may be a metal film with at least one orifice 31 formed thereon aligning with the injection port 110. Hence the injection material can be injected through the injection port 110 and orifice 31 into the mold cavity. An organic material layer 2 also is provided and placed in the mold cavity in advance so that the injection material can be injected through the orifice 31 onto an inner surface of the organic material layer 2. Referring to FIG. 3, with the organic material layer 2 and bottom layer 3 positioned in the mold cavity, the injection material injected through the injection port 110 and orifice 31 forms an injection material layer 4 between the organic material layer 2 and bottom layer 3. The injection material layer 4 is bonded to the organic material layer 2 and bottom layer 3 in the mold cavity to form a shape mating the mold cavity.

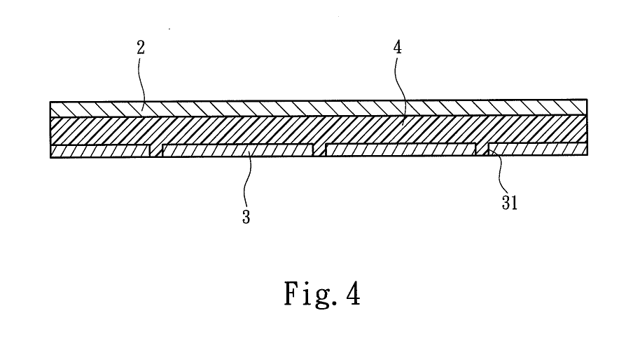

Refer to FIG. 4 for the industrial product released from the mold after having finished the injection process shown in FIGS. 2 and 3. The industrial product thus formed at least includes the organic material layer 2, injection material layer 4 and bottom layer 3. The organic material layer 2 is exposed on the outer surface of the industrial product. The bottom layer 3 is located on another side of the organic material layer 2. The injection material layer 4 is interposed between the organic material layer 2 and bottom layer 3 to bond them together. If only the organic material layer 2 is bonded to the injection material layer 4, the injection material layer 4 could be warped with the organic material layer 2. In the invention, the injection material layer 4 has another side bonded to the bottom layer 3 which helps to distribute the warping force exerted to the injection material layer 4 so that warping of the organic material 2 and injection material layer 4 is suppressed by the bottom layer 3. By suppressing the warping of the organic material layer 2 and injection material layer 4, they receive much smaller stress over a long period of time than the conventional structure. As a result, the fine profile of the industrial product can be maintained and the lifespan thereof increases. Moreover, as previously discussed, the bottom layer 3 can be a metal film which provides electromagnetic interference (EMI) protection function and can protect electronic elements surrounding the industrial product from being affected by the electromagnetic waves. The organic material layer 2 exposed out of the surface of the industrial product can be selected from the group consisting of leaves, flower petals, bamboo skins and leather. The industrial product thus formed, besides providing touch feeling and appearance different from plastics, also can enhance product value and identification.

The bottom layer 3 can be a composite film consisting of a plurality of materials. The composite film can include a metal material to provide protective function against EMI. There is no limitation on material selection of the bottom layer 3, which may select material having varying shrinkage rate to adjust deformation degree of the industrial product.

As a conclusion, the invention provides the bottom layer 3 with an orifice 31 formed thereon to allow the injection material layer 4 to be formed between the organic material layer 2 and bottom layer 3 to reinforce total physical strength and suppress warping of the organic material layer 2 and bottom layer 3, thereby can overcome many problems such as unsightly appearance that might otherwise take place caused by warping after a long period of time. The injection material can be selected from the group consisting of Polyethylene terephthalate (PET), Polyethylene naphthalate (PEN), Polyethylene glycol-co-cyclohexane-1,4 dimethanol terephthalate (PETG), Thermalplastic polyurethane (TPU), Polyurethane (PU), Polypropylene (PP), Polycarbonate (PC), Amorphous polyethylene terephthalate (A-PET), Polyvinyl chloride (PVC), Acrylic, Methly-methacrylate-styrene (MS), Acrylonitrile-butadiene-styrene copolymer, Polystyrene (PS), Polyoxymethylene (POM), Nylon, and combinations thereof.

While the invention has been described by means of specific embodiment, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. An industrial product structure combined with organic material being formed in an injection mold which includes a mold cavity and at least one injection port to allow an injection material to be injected into the mold cavity, comprising:
an organic material layer on the surface thereof;
a bottom layer including at least one orifice; and
an injection material layer formed by injecting the injection material through the injection port and the orifice between the organic material layer and the bottom layer, the injection material being bonded to the organic material layer and the bottom layer and formed in the mold cavity.

2. The industrial product structure of claim 1, wherein the organic material layer is placed in the mold cavity in advance to allow the injection material to be injected onto an inner surface of the organic material layer so that the organic material layer is exposed on an outer surface of the industrial product.

3. The industrial product structure of claim 1, wherein the bottom layer is placed in the mold cavity in advance to allow the injection material to pass through the orifice and be injected between the organic material layer and the bottom layer.

4. The industrial product structure of claim 1, wherein the bottom layer is a metal film.

5. The industrial product structure of claim 1, wherein the bottom layer is a composite film consisting of a plurality of types of materials.

6. The industrial product structure of claim 5, wherein the composite film includes a metal material.

7. The industrial product structure of claim 1, wherein the organic material layer is made of a material selected from the group consisting of leaves, flower petals, bamboo skins and leather.

8. The industrial product structure of claim 1, wherein the injection material is selected from the group consisting of Polyethylene terephthalate (PET), Polyethylene naphthalate (PEN), Polyethylene glycol-co-cyclohexane-1,4 dimethanol terephthalate (PETG), Thermalplastic polyurethane (TPU), Polyurethane (PU), Polypropylene (PP), Polycarbonate (PC), Amorphous polyethylene terephthalate (A-PET), Polyvinyl chloride (PVC), Acrylic, Methly-methacrylate-styrene (MS), Acrylonitrile-butadiene-styrene copolymer, Polystyrene (PS), Polyoxymethylene (POM), Nylon, and combinations thereof.
